(19) United States
(12) Patent Application Publication
(10) Pub. No.: US 2026/0101356 A1
(43) Pub. Date: Apr. 9, 2026

(54) METHOD AND DEVICE FOR TRANSMITTING SYSTEM INFORMATION, AND READABLE STORAGE MEDIUM

(71) Applicant: Beijing Xiaomi Mobile Software Co., Ltd., Beijing (CN)

(72) Inventors: Ting FU, Beijing (CN); Yumin WU, Beijing (CN)

(21) Appl. No.: 19/112,891

(22) PCT Filed: Sep. 20, 2022
(86) PCT No.: PCT/CN2022/120002

§ 371 Date: Mar. 18, 2025

(51) Int. Cl. H04W 72/232

(52) U.S. Cl. CPC H04W 72/232

(57) ABSTRACT

A method for sending system information (SI), including: sending, within one system information time window, a downlink control information (DCI) corresponding to a plurality of SI.

### CROSS-REFERENCE TO RELATED APPLICATIONS

The present application is a U.S. National Stage of International Application No. PCT/CN2022/120002, filed on Sep. 20, 2022, the contents of all of which are incorporated herein by reference in their entireties for all purposes.

### BACKGROUND OF THE INVENTION

In some scenarios of 5G new radio (NR), such as scenarios of cell search, user equipment (UE) needs to acquire system information (SI). A mode of acquiring the system information by the UE is: first obtaining a system information block 1 (SIB1), which includes scheduling information of one or more SI. Each SI includes one or more SIBs, which are SIBs other than the SIB1, i.e., other system information (other SI).

### SUMMARY OF THE INVENTION

The present disclosure relates to wireless communication technology, in particular to a method and device for transmitting system information, and a readable storage medium.

In a first aspect, the present disclosure provides a method for sending system information. The method is performed by a network device and includes:
sending, within one system information time window, a downlink control information (DCI) corresponding to a plurality of system information (SI).

In a second aspect, the present disclosure provides a method for receiving system information. The method is performed by a user equipment and includes:
receiving, within one system information time window, DCI corresponding to a plurality of SI.

In a third aspect, the present disclosure provides a communication device. The communication device includes one or more processors and a memory. The memory is configured to store a computer program; and the one or more processors are collectively configured to execute the computer program to implement the first aspect or any one of possible designs of the first aspect.

In a fourth aspect, the present disclosure provides a communication device. The communication device includes one or more processors and a memory. The memory is configured to store a computer program; and the one or more processors are collectively configured to execute the computer program to implement the second aspect or any one of possible designs of the second aspect.

In a fifth aspect, the present disclosure provides a non-transitory computer-readable storage medium. The computer-readable storage medium stores instructions (or referred to as computer programs, programs), and the instructions, when invoked and executed on a computer, cause the computer to perform the first aspect or any one of possible designs of the first aspect.

In a sixth aspect, the present disclosure provides a non-transitory computer-readable storage medium. The computer-readable storage medium stores instructions (or referred to as computer programs, and programs), and the instructions, when invoked and executed on a computer, cause the computer to perform the second aspect or any one of possible designs of the second aspect.

It is to be understood that the above general descriptions and later detailed descriptions are merely examples and explanations, and cannot limit the present disclosure.

### BRIEF DESCRIPTION OF DRAWINGS

Accompanying drawings illustrated here are used to provide a further understanding of embodiments of the present disclosure and constitute a part of the present disclosure. Examples of the embodiments of the present disclosure and descriptions of the examples are used to explain the embodiments of the present disclosure and do not constitute an undue limitation on the embodiments of the present disclosure. In the accompanying drawings:
the accompanying drawings, which are incorporated in the specification and constitute a part of the specification, illustrate embodiments consistent with the embodiments of the present disclosure and serve to explain the principles of the embodiments of the present disclosure together with the specification.

FIG. 1 is a schematic diagram of a wireless communication system architecture according to an embodiment of the present disclosure.

FIG. 2 is a flowchart of a method for transmitting system information according to an example.

FIG. 3 is a flowchart of a method for sending system information according to an example.

FIG. 4 is a flowchart of a method for sending system information according to another example.

FIG. 5 is a flowchart of a method for sending system information according to another example.

FIG. 6 is a schematic diagram of SI transmission according to an example.

FIG. 7 is a flowchart of a method for receiving system information according to an example.

FIG. 8 is a block diagram of a device for sending system information according to an example.

FIG. 9 is a block diagram of a communication device according to an example.

FIG. 10 is a block diagram of a device for receiving system information according to an example.

FIG. 11 is a block diagram of user equipment according to an example.

### DETAILED DESCRIPTION OF THE INVENTION

Embodiments of the present disclosure will now be further illustrated in combination with accompanying drawings and specific implementations.

Examples will be described in detail here, instances of which are represented in the accompanying drawings. When the following description refers to the accompanying drawings, unless otherwise indicated, the same numbers in different accompanying drawings indicate the same or similar elements. The implementations described in the following examples do not represent all implementations consistent with the embodiments of the present disclosure. Rather, they are merely instances of devices and methods consistent with some aspects of the present disclosure as detailed in the appended claims.

Terms used in the embodiments of the present disclosure are merely for the purpose of describing specific embodiments, and not intended to limit the embodiments of the present disclosure. The singular forms “a” and “the” used in the embodiments of the present disclosure and the appended claims are also intended to include plural forms unless the context clearly indicates other meanings. It is also to be understood that the term “and/or” as used here refers to and includes any or all possible combinations of one or more associated listed items.

It is to be understood that although terms “first”, “second”, “third”, etc. may be used to describe various information in the embodiments of the present disclosure, such information are not limited to these terms. These terms are merely used to distinguish the same type of information from each other. For example, without departing from the scope of the embodiments of the present disclosure, first information may also be referred to as second information, and similarly, the second information may also be referred to as the first information. Depending on the context, words “if” and “when” as used here may be interpreted as “in a case where” or “in the event that” or “in response to determining”.

The embodiments of the present disclosure will be described below in detail, instances of which are illustrated in the accompanying drawings. The same or similar reference numerals represent the same or similar elements throughout. The embodiments described below with reference to the accompanying drawings are illustrative, and are intended to explain the present disclosure and cannot be construed as limiting the present disclosure.

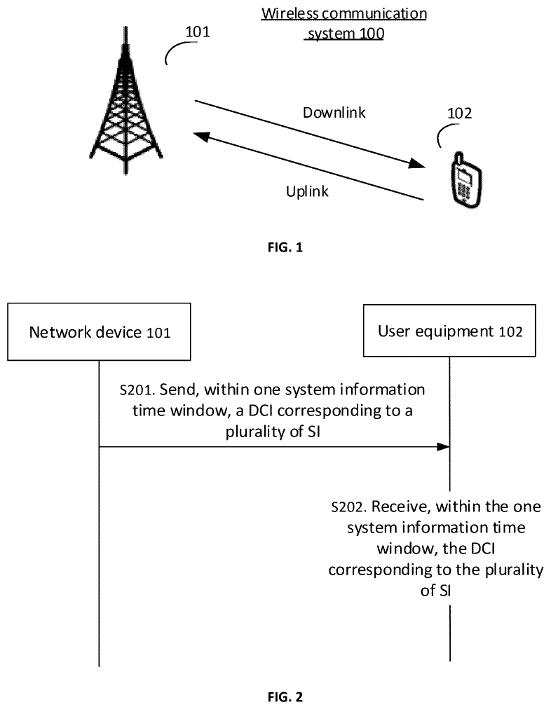

As shown in FIG. 1, a method for transmitting system information according to an embodiment of the present disclosure may be applied to a wireless communication system 100. The wireless communication system may include user equipment 102 and a network device 101. The user equipment 102 is configured to support carrier aggregation and may be connected to a plurality of carrier units of the network device 101 including a primary carrier unit and one or more secondary carrier units.

It is to be understood that the above wireless communication system 100 may be applicable to both low-frequency and high-frequency scenarios. The application scenarios of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, future 5th-generation (5G) systems, new radio (NR) communication systems, or future evolved public land mobile network (PLMN) systems, and the like.

The user equipment 102 shown above may be a terminal, an access terminal, a terminal unit, a terminal station, a mobile station (MS), a remote station, a remote terminal, a mobile terminal, a wireless communication device, a terminal agent, or a terminal device, etc. The user equipment 102 may have a wireless transceiving function, and is capable of communicating (e.g., wirelessly communicating) with one or more network devices of one or more communication systems and accepting network services provided by the network devices, and the network devices here include, but are not limited to, the illustrated network device 101.

The user equipment (UE) 102 may be a cellular telephone, a cordless telephone, a session initiation protocol (SIP) telephone, a wireless local loop (WLL) station, a personal digital assistant (PDA) device, a handheld device with a wireless communication function, a computing device or other processing devices connected to a wireless modem, an in-vehicle device, a wearable device, a terminal device in a future 5G network or a terminal device in a future evolved PLMN, and the like.

The network device 101 may be an access network device (or referred to as access network site). The access network device is a device with a function of providing network access, such as a radio access network (RAN) base station. The network device 101 may specifically include a base station (BS), or include a base station and a wireless resource management device for controlling the base station, etc. The network device 101 may further include relay stations (relay devices), access points, and base stations in future 5G networks, base stations in future evolved PLMNs, or NR base stations, and the like. The network device 101 may be a wearable device or an in-vehicle device. The network device 101 may also be a communication chip with a communication module.

For example, the network device 101 includes, but is not limited to: a gnodeB (gNB) in 5G, an evolved node B (eNB) in an LTE system, a radio network controller (RNC), a node B (NB) in a WCDMA system, a wireless controllers under a CRAN system, a base station controller (BSC), a base transceiver station (BTS) in a GSM system or CDMA system, a femtocell (e.g., home evolved nodeB, or home node B (HNB)), a baseband unit (BBU), a transmitting and receiving point (TRP), a transmitting point (TP) or a mobile switching center, and the like.

In the related art, each SI has its own corresponding system information time window (SI window), and the SI windows corresponding to the SI do not overlap at all in a time domain. The network device can schedule one SI within one SI window. If the base station wishes to broadcast a plurality of SI, SI scheduling needs to be performed repeatedly in a plurality of SI windows, and the user equipment also needs to perform monitoring and receiving separately in the plurality of SI windows, which thus is not conducive to energy saving of both the network device and the user equipment.

An embodiment of the present disclosure provides a method for transmitting system information. FIG. 2 is a flowchart of a method for transmitting system information according to an example. As shown in FIG. 2, the method includes steps S201-S202, specifically as follows.

In step S201, the network device 101 sends, within one system information time window, a downlink control information (DCI) corresponding to a plurality of system information (SI).

In step S202, the user equipment 102 receives, within the one system information time window, the DCI corresponding to the plurality of SI.

It is worth noting that according to the 3rd Generation Partnership Project (3GPP) Release 17 (R17) and the protocol of the previous version, each SI correspond to one SI window, and the correspondence is noted as a default correspondence.

In some possible implementations, the one system information time window in which the network device 101 sends the DCI is noted as a first SI window, and the plurality of SI correspond to the same first SI window.

In some possible implementations, the network device 101 determines a time domain position of the first SI window based on relevant parameters.

In some possible implementations, the network device 101 sends the DCI in a search space configured to schedule system information within the one system information time window. The search space for scheduling the system information is a search space for transmitting and scheduling other system information (other SI) located within the first SI window.

In some possible implementations, the network device 101 sends one or more DCI within the first SI window to schedule a plurality of SI.

In some possible implementations, the network device 101 schedules a physical downlink shared channel (PDSCH) via the DCI, the PDSCH carrying information of the scheduled SI.

In some possible implementations, the network device 101 sends the DCI in a broadcasting mode within the first SI window. The DCI is scrambled using an SI radio network temporary identifier (SI-RNTI).

In some possible implementations, the user equipment 102 monitors a physical downlink control channel (PDCCH) within the first SI window to obtain the DCI sent by the network device 101. The PDSCH and the SI carried by the PDSCH are obtained based on the DCI.

In the embodiment of the present disclosure, the network device 101 sends the DCI within one system information time window to schedule the plurality of SI. As a result, the network device 101 does not need to be in an operating state within a plurality of system information time windows, so that the time when the network device 101 is in an operating state is shortened, and energy saving of the network device 101 is achieved. The user equipment 102 may monitor and receive the SI within one system information time window, so that the duration for which the user equipment is in a monitoring state is shortened, and energy saving of the user equipment is achieved.

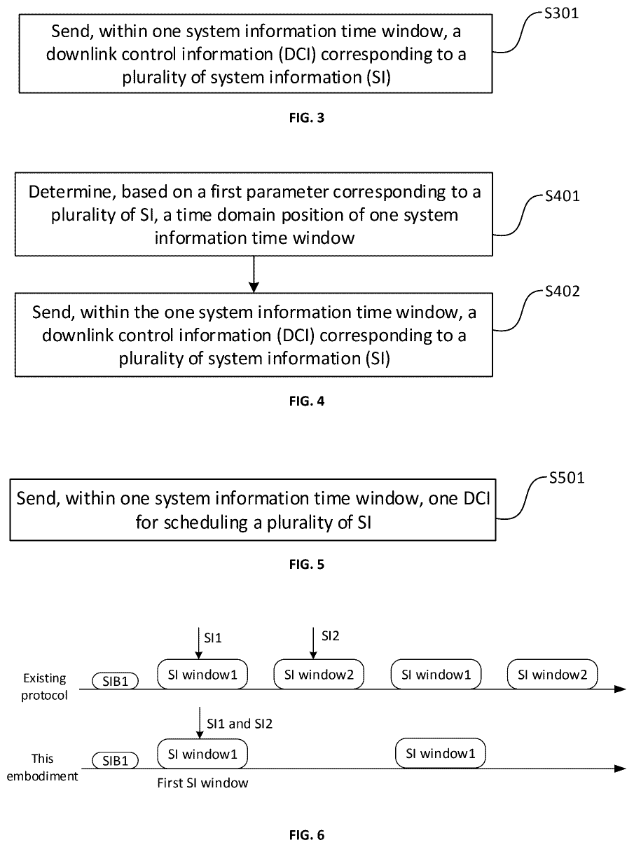

An embodiment of the present disclosure provides a method for sending system information, and the method is performed by a network device 101. FIG. 3 is a flowchart of a method for sending system information according to an example. As shown in FIG. 3, the method includes step S301, specifically as follows.

In step S301, the network device 101 sends, within one system information time window, a downlink control information (DCI) corresponding to a plurality of system information (SI).

In some possible implementations, the one system information time window in which the network device 101 sends the DCI is noted as a first SI window, and the plurality of SI correspond to the same first SI window.

In some possible implementations, the network device 101 determines a time domain position of the first SI window based on relevant parameters.

In some possible implementations, the network device 101 sends one or more DCI within the first SI window to schedule a plurality of SI.

In some possible implementations, the network device 101 sends the DCI in a broadcasting mode within the first SI window.

In some possible implementations, periods of a system information time window corresponding to each SI among the plurality of SI are the same or different.

In one example, the periods of a system information time window corresponding to each SI are the same and may be 8 radio frames, 16 radio frames, 32 radio frames, or 64 radio frames, with one radio frame being 10 ms.

In another example, the periods of a system information time window corresponding to each SI are different, in which case the periods of different SI are integer multiples. For example, SI 1 corresponds to a period of 8 radio frames and SI 2 corresponds to a period of 16 radio frames.

In the embodiment of the present disclosure, the network device 101 sends the DCI within one system information time window to schedule a plurality of SI. As a result, the network device 101 does not need to be in an operating state within a plurality of system information time windows, so that the time when the network device 101 is in an operating state is shortened, and energy saving of the network device 101 is achieved.

An embodiment of the present disclosure provides a method for sending system information, and the method is performed by a network device 101. FIG. 4 is a flowchart of a method for sending system information according to an example. As shown in FIG. 4, the method includes steps S401-S402, specifically as follows.

In step S401, the network device 101 determines, based on a first parameter corresponding to a plurality of SI, a time domain position of one system information time window, the plurality of SI correspond to the same first parameter.

In step S402, the network device 101 sends, within the one system information time window, a downlink control information (DCI) corresponding to the plurality of system information (SI).

In some possible implementations, the one system information time window in which the network device 101 sends the DCI is noted as a first SI window.

In some possible implementations, the network device 101 determines, based on the first parameter, a system frame number (SFN) where the first SI window is located and a starting time domain position. The starting time domain position may be a starting slot, or a starting symbol, and the like.

In some possible implementations, the network device 101 may configure the first parameter to be a set value, for example, the first parameter is 0.

In some possible implementations, the plurality of SI correspond to the same first parameter, and the network device 101 may determine the same first SI window corresponding to the plurality of SI based on the first parameter, i.e., the SI windows of the plurality of SI overlap at the first SI window.

In the embodiment of the present disclosure, the network device 101 determines the same first SI window corresponding to each SI by configuring the same first parameter for each SI, so that the plurality of SI are scheduled in the same SI window, which saves energy consumption.

An embodiment of the present disclosure provides a method for sending system information, and the method is performed by a network device 101. The method includes steps S401′-S402, specifically as follows.

In step S401′, the network device 101 determines, based on a set function associated with a first parameter, a starting time domain position of one system information time window and a system frame number where the one system information time window is located.

In step S402, the network device 101 sends, within the one system information time window, a downlink control information (DCI) corresponding to a plurality of system information (SI).

The one system information time window in which the network device 101 sends the DCI is noted as a first SI window.

In some possible implementations, the set function associated with the first parameter is denoted as f(the first parameter).

In some possible implementations, the starting time domain position may be a starting slot, or a starting symbol, etc. When the starting time domain position is the starting slot, a starting slot #a of the first SI window may be determined with reference to the following method:
α=ƒ(the first parameter) mod N, where N denotes a number of slots included in a radio frame, and mod denotes a modulo operation.

In some possible implementations, the SFN where the first SI window is located may be determined with reference to the following method:
SFN mod T=FLOOR(ƒ(the first parameter)/N), where T denotes a period of an SI window, and FLOOR denotes a round-down operation.

In some possible implementations, periods of a system information time window corresponding to each SI among the plurality of SI are the same or different.

In one example, the periods of a system information time window corresponding to each SI are the same and may be 8 radio frames, 16 radio frames, 32 radio frames, or 64 radio frames, with one radio frame being 10 ms.

In another example, the periods of a system information time window corresponding to each SI are different, in which case the periods of different SI are integer multiples. For example, SI 1 corresponds to a period of 8 radio frames and SI 2 corresponds to a period of 16 radio frames.

In some possible implementations, ƒ(the first parameter)=the first parameter*(SI window length). A system information window length (SI window length) of each scheduled SI are same, and the SI window length is measured in slots.

In some possible implementations, the network device 101 may configure the first parameter to be a set value, for example, the first parameter is 0, 1, 2, and so forth.

An embodiment of the present disclosure provides a method for sending system information, and the method is performed by a network device 101. FIG. 5 is a flowchart of a method for sending system information according to an example. As shown in FIG. 5, the method includes step S501, specifically as follows.

In step S501, the network device 101 sends, within one system information time window, one DCI for scheduling a plurality of SI. The one DCI is configured to schedule a plurality of physical downlink shared channels (PDSCHs), and each PDSCH carries one corresponding SI among the plurality of SI.

In the embodiment of the present disclosure, the network device 101 schedules a plurality of SI via one DCI, so that a number of broadcasts or signaling of the network device 101 can be decreased, and energy consumption is further saved.

An embodiment of the present disclosure provides a method for sending system information, and the method is performed by a network device 101. The method includes step S501.

Among a plurality of PDSCHs scheduled by the one DCI, SI corresponding by default to a system information time window is carried on a first PDSCH.

In some possible implementations, the SI corresponding by default refers to SI corresponding to each SI window according to 3GPP R17 and the protocol before 3GPP R17.

In some possible implementations, by scheduling a plurality of PDSCHs via one DCI, the normal reception of SI by legacy UE may not be affected. It is to be understood that the legacy UE refers to UE based on 3GPP R17 and the protocol before 3GPP R17.

To facilitate understanding of this embodiment, a specific example is set forth below.

### Example 1

A plurality of SI indicated to be scheduled in SIB 1 include SI 1 and SI 2. SI 1 includes SIB 2 and SIB 3, and SI 2 includes SIB 4 and SIB 5.

Referring to FIG. 6, according to 3GPP R17 and the protocol before 3GPP R17, a time window corresponding to SI 1 is SI window 1, and a time window corresponding to SI 2 is SI window 2. The network device 101 schedules SI 1 in SI window 1, for example, a first DCI is broadcasted in SI window 1, the first DCI is configured to schedule a first PDSCH, and the first PDSCH carries SI 1. The network device 101 schedules SI 2 in SI window 2, for example, a second DCI is broadcasted in SI window 2, the second DCI is configured to schedule a second PDSCH, and the second PDSCH carries SI 2. As a result, the network device 101 needs to broadcast information in a plurality of SI windows, and correspondingly, the user equipment 102 also needs to monitor a PDCCH in each SI window to receive SI, which is not conducive to energy saving of the network device 101 and the user equipment 102.

In this example, assuming that the first SI window determined by the network device 101 based on the first parameter is SI window 1, the network device 101 will schedule SI 1 and SI 2 in SI window 1. For example, the network device 101 sends one DCI within SI window 1, the one DCI schedules the first PDSCH and the second PDSCH, the first PDSCH is configured to carry SI 1 corresponding by default to SI window 1, and the second PDSCH is configured to carry SI 2.

In this example, the normal reception of SI by the legacy UE is not affected, that is, the legacy UE just acquires the SI in the first PDSCH.

An embodiment of the present disclosure provides a method for sending system information, and the method is performed by a network device 101. The method includes steps S501-S502, specifically as follows.

In step S501, the network device 101 sends, within the one system information time window, one DCI for scheduling a plurality of SI. The one DCI is configured to schedule a plurality of physical downlink shared channels (PDSCHs), and each PDSCH carries one corresponding SI among the plurality of SI.

In step S502, the network device 101 sends a first signaling, where the first signaling is configured to indicate that the plurality of PDSCHs are allowed to be scheduled via the one DCI for transmission of the plurality of SI.

The order of steps S501 and S502 is not limited in this embodiment, for example, step S502 may be performed first.

In some possible implementations, the first signaling is a high-level signaling, for example, an RRC signaling, or SIB1.

In some possible implementations, the DCI is scrambled using an SI radio network temporary identifier (SI-RNTI), and the one DCI schedules the plurality of PDSCHs for carrying a plurality of SI.

In the embodiment of the present disclosure, the network device 101 informs the user equipment 102 of a way for scheduling the system information this time by sending the first signaling, that is, the plurality of PDSCHs configured to transmit the corresponding SI are scheduled via one DCI.

An embodiment of the present disclosure provides a method for sending system information, and the method is performed by a network device 101. The method includes steps S501-S503, specifically as follows.

In step S501, the network device 101 sends, within the one system information time window, one DCI for scheduling a plurality of SI. The one DCI is configured to schedule a plurality of physical downlink shared channels (PDSCHs), and each PDSCH carries one corresponding SI among the plurality of SI.

In step S503, the network device 101 sends a second signaling, where the second signaling is configured to indicate a number of the PDSCHs scheduled via the one DCI.

In some possible implementations, the second signaling may be a high-level signaling configured by the network device 101 in addition to the first signaling.

In the embodiments of the present disclosure, the network device 101 configures, by way of signaling configuration, a number of the PDSCHs that may be scheduled via one DCI, and the user equipment 102 may perform monitoring or SI reception based on the signaling.

An embodiment of the present disclosure provides a method for sending system information, and the method is performed by a network device 101. The method includes step S501, specifically as follows.

In step S501, the network device 101 sends, within the one system information time window, one DCI for scheduling a plurality of SI. The one DCI is configured to schedule a plurality of physical downlink shared channels (PDSCHs), and each PDSCH carries one corresponding SI among the plurality of SI. The DCI is scrambled using an SI-RNTI.

A set information field of the one DCI is configured to indicate a number of the PDSCHs scheduled by the one DCI.

In some possible implementations, 2 bits may be occupied in the set information field, for example.

In some possible implementations, the set information field is configured in reserved bits of the one DCI.

In an example, when DCI format 1-0 is configured to schedule SI, based on existing protocols, DCI 1-0 under an authorized spectrum may have 17 bits as reserved bits at the end, and DCI 1-0 under an unauthorized spectrum may have 15 bits as reserved bits at the end. One or more bits in reserved bits are used as the set information field. It may be understood that legacy UE does not demodulate information in the reserved bits.

In the embodiments of the present disclosure, by utilizing the DCI for scheduling the SI, a number of the scheduled PDSCHs are indicated. The set information field is set in the reserved bits of the DCI, normal reception of the DCI by the legacy UE may not be affected.

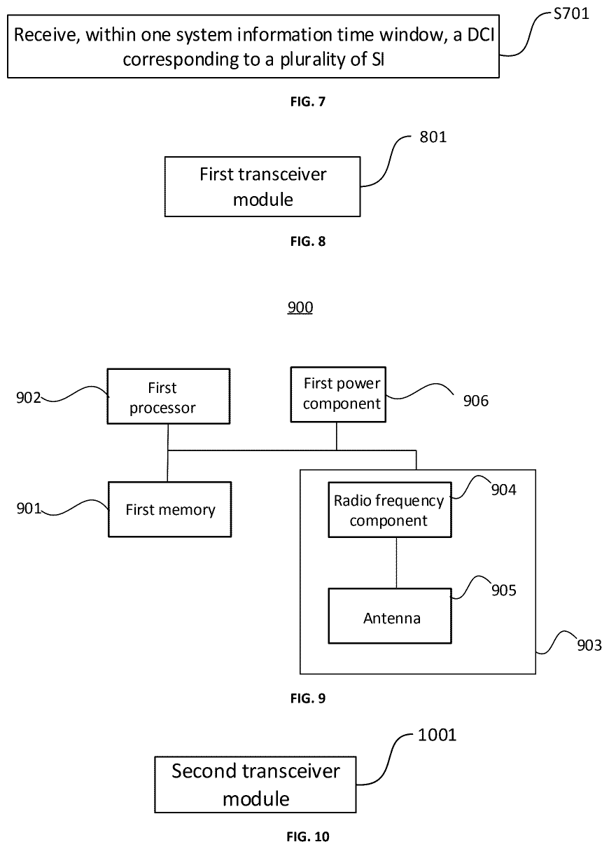

An embodiment of the present disclosure provides a method for receiving system information, and the method is performed by user equipment 102. FIG. 7 is a flowchart of a method for receiving system information according to an example. As shown in FIG. 7, the method includes step S701, specifically as follows.

In step S701, the user equipment 102 receives, within one system information time window, DCI corresponding to a plurality of SI.

In some possible implementations, the one system information time window is noted as a first SI window, and the plurality of SI correspond to the same first SI window.

In some possible implementations, a search space for scheduling the system information is a search space for transmitting and scheduling other system information (other SI) located within the first SI window.

In some possible implementations, the user equipment 102 monitors PDCCHs within the first SI window to obtain DCI and obtains the PDSCHs scheduled by the DCI, as well as SI carried by the PDSCHs.

In the embodiments of the present disclosure, the user equipment 102 may monitor and receive the DCI sent by the network device 101 within one system information time window to receive a plurality of SI. As a result, the duration for which the user equipment 102 is in a monitoring state can be shortened, and energy saving of the user equipment 102 is achieved.

An embodiment of the present disclosure provides a method for receiving system information, and the method is performed by user equipment 102. The method includes steps S700-S701, specifically as follows.

In step S700, the user equipment 102 determines, based on a first parameter corresponding to a plurality of SI, a time domain position of one system information time window, where the plurality of SI correspond to the same first parameter.

In step S701, the user equipment 102 receives, within the one system information time window, DCI corresponding to the plurality of SI.

In some possible implementations, the first parameter is configured by a network device 101.

In an example, before step S700, the method may further include step S700′ as follows.

In step S700′, the user equipment 102 receives information sent by the network device 101 for configuring the first parameter.

In some possible implementations, the user equipment 102 may receive SIB1 of the network device 101, the SIB1 including the first parameter.

In some possible implementations, the SIB1 includes scheduling information for one or more SI, such as an SI window period and an SI window length for each SI.

In some possible implementations, the user equipment 102 may determine, based on the first parameter, a system frame number (SFN) where the first SI window is located and a starting time domain position. The starting time domain position may be a starting slot, or a starting symbol, and the like. The user equipment 102 may determine the starting slot with reference to the aforementioned way for determining a starting slot #a, and determine the SFN in accordance with the aforementioned way for determining the SFN.

In some possible implementations, the user equipment 102 determines, based on a set function ƒ(the first parameter) associated with the first parameter, a starting time domain position of the one system information time window and a system frame number where the one system information time window is located.

In some possible implementations, the starting time domain position is a starting slot; and the starting slot α satisfies:
α=ƒ(the first parameter) mod N, where ƒ(the first parameter) denotes the set function, N denotes a number of slots included in a radio frame, and mod denotes a modulo operation.

In some possible implementations, the system frame number (SFN) satisfies:
SFN mod T=FLOOR(ƒ(the first parameter)/N), where T denotes a period of an SI window, ƒ(the first parameter) denotes the set function, N denotes a number of slots included in a radio frame, and FLOOR denotes a round-down operation.

In the embodiments of the present disclosure, the user equipment 102 may determine, based on the configuration of the network device 101, a time domain position of the first SI window to monitor a PDCCH at a suitable position, so as to obtain the SI.

An embodiment of the present disclosure provides a method for receiving system information, and the method is performed by user equipment 102. The method includes steps S701-1 to S701-2, specifically as follows.

In step S701-1, the user equipment 102 receives, within one system information time window, one DCI for scheduling a plurality of SI.

In step S701-2, the user equipment 102 determines, according to the one DCI, a plurality of PDSCHs scheduled by the one DCI and one corresponding SI carried by each PDSCH.

In some possible implementations, the user equipment 102 may receive a first signaling sent by the network device 101 and be informed that the network device 101 schedules the plurality of PDSCHs for transmitting the SI via one DCI.

The one DCI for scheduling the plurality of PDSCHs is scrambled with an SI-RNTI.

In some possible implementations, the user equipment 102 may receive a second signaling sent by the network device 101 and be informed of a number of the PDSCHs scheduled by the one DCI, so as to accurately receive each PDSCH for carrying the SI.

In some possible implementations, the user equipment 102 may also be informed of a number of the PDSCHs scheduled by the DCI based on a set information field of the DCI.

In some possible implementations, SI corresponding by default to the system information time window is carried on a first PDSCH among the plurality of PDSCHs scheduled by the one DCI. The SI corresponding by default refers to SI corresponding to each SI window according to 3GPP R17 and the protocol before 3GPP R17.

Legacy UE may just obtain the SI carried by the first PDSCH among the plurality of PDSCHs scheduled by the one DCI.

In the embodiments of the present disclosure, in a scenario where the plurality of PDSCHs are scheduled by the network device 101 via one DCI, the user equipment 102 may obtain the SI based on the one DCI.

Based on the same idea as the above method embodiments, an embodiment of the present disclosure further provides a device for sending system information. The device may have the functions of the network device 101 in the above method embodiments and may be configured to perform the steps performed by the network device 101 in the above method embodiments. The functions may be realized by hardware, or may also be realized by software or hardware executing corresponding software. The hardware or software includes one or more modules corresponding to the above-described functions.

In one possible implementation, a device 800 as shown in FIG. 8 may act as the network device 101 involved in the above method embodiments and perform the steps performed by the network device 101 in the above method embodiments. As shown in FIG. 8, the device 800 may include a first transceiver module 801, and the first transceiver module 801 may be configured to support a communication device in communication.

When the steps implemented by the network device 101 are performed, the first transceiver module 801 is configured to send, within one system information time window, a downlink control information (DCI) corresponding to a plurality of system information (SI).

In some possible implementations, the device 800 further includes a processing module coupled to the first transceiver module 801. The processing module is configured to determine, based on a first parameter corresponding to the plurality of SI, a time domain position of the one system information time window, where the plurality of SI correspond to the same first parameter.

In some possible implementations, the processing module is further configured to determine, based on a set function associated with the first parameter, a starting time domain position of the one system information time window and a system frame number where the one system information time window is located.

In some possible implementations, the starting time domain position is a starting slot; and
the starting slot α satisfies:
   α=ƒ(the first parameter) mod N, where ƒ(the first parameter) denotes the set function, N denotes a number of slots included in a radio frame, and mod denotes a modulo operation.

In some possible implementations, the system frame number (SFN) satisfies:
SFN mod T=FLOOR(ƒ(the first parameter)/N), where T denotes a period of an SI window, ƒ(the first parameter) denotes the set function, N denotes a number of slots included in a radio frame, and FLOOR denotes a round-down operation.

In some possible implementations, the first transceiver module 801 is further configured to send, within the one system information time window, one DCI for scheduling a plurality of SI. The one DCI is configured to schedule a plurality of physical downlink shared channels (PDSCHs), and each PDSCH carries one corresponding SI among the plurality of SI.

In some possible implementations, SI corresponding by default to the system information time window is carried on a first PDSCH among the plurality of PDSCHs scheduled by the one DCI.

In some possible implementations, the first transceiver module 801 is configured to send a first signaling, where the first signaling is configured to indicate that the plurality of PDSCHs are allowed to be scheduled via the one DCI for transmission of the plurality of SI.

In some possible implementations, the first transceiver module 801 is configured to send a second signaling, where the second signaling is configured to indicate a number of the PDSCHs scheduled via the one DCI.

In some possible implementations, a set information field of the one DCI is configured to indicate a number of the PDSCHs scheduled by the one DCI.

In some possible implementations, the set information field is configured in reserved bits of the one DCI.

In some possible implementations, periods of a system information time window corresponding to each SI among the plurality of SI are the same or different.

When the communication device is the network device 101, the structure of the communication device may also be shown in FIG. 9. The structure of the communication device is illustrated using a base station as an example. As shown in FIG. 9, a device 900 includes a first memory 901, a first processor 902, a transceiver component 903, and a first power component 906. The first memory 901 is coupled to the first processor 902 and may be used to save programs and data need for the communication device 900 to implement various functions. The first processor 902 is configured to support the communication device 900 in performing the corresponding functions in the method described above. The functions may be realized by invoking the programs stored in the first memory 901. The transceiver component 903 may be a wireless transceiver that may be used to support the communication device 900 in receiving signaling and/or data, and sending the signaling and/or data using a wireless radio. The transceiver component 903 may also be referred to as a transceiver unit or a communication unit, and the transceiver component 903 may include a radio frequency component 904 and one or more antennas 905. The radio frequency component 904 may be a remote radio unit (RRU), which may be specifically used to transmit radio frequency signals and convert between the radio frequency signals and baseband signals. The one or more antennas 905 may be specifically used to radiate and receive the radio frequency signals.

When the communication device 900 needs to send data, the first processor 902 may output the baseband signals to a radio frequency unit after performing baseband processing on the data to be sent, and the radio frequency unit sends the radio frequency signals in a form of electromagnetic waves through the antennas after performing radio frequency processing on the baseband signals. When data is sent to the communication device 900, the radio frequency unit receives the radio frequency signals through the antennas, converts the radio frequency signals to the baseband signals, and outputs the baseband signals to the first processor 902, and the first processor 902 converts the baseband signals to data and processes the data.

Based on the same idea as the above method embodiments, an embodiment of the present disclosure further provides a device for receiving system information. The device may have the functions of the user equipment 102 in the above method embodiments and may be configured to perform the steps performed by the user equipment 102 in the above method embodiments. The functions may be realized by hardware, or may also be realized by software or hardware executing corresponding software. The hardware or software includes one or more modules corresponding to the above-described functions.

In one possible implementation, a communication device 1000 as shown in FIG. 10 may act as the user equipment 102 involved in the above method embodiments and perform the steps performed by the user equipment 102 in the above method embodiments. As shown in FIG. 10, the communication device 1000 may include a second transceiver module 1001. The second transceiver module 1001 may be configured to support the communication device in communication, and the second transceiver module 1001 may have a wireless communication function, such as being able to communicate wirelessly with other communication devices via a wireless radio.

In performing the steps performed by the user equipment 102, the second transceiver module 1001 is configured to receive, within one system information time window, DCI corresponding to a plurality of SI.

In some possible implementations, the device 1000 further includes a processing module coupled to the second transceiver module 1001. The processing module is configured to determine, based on a first parameter corresponding to the plurality of SI, a time domain position of the one system information time window, the plurality of SI correspond to the same first parameter.

In some possible implementations, the second transceiver module 1001 is further configured to receive information sent by the network device for configuring the first parameter.

In some possible implementations, the processing module is further configured to determine, based on a set function associated with the first parameter, a starting time domain position of the one system information time window and a system frame number where the system information time window is located.

In some possible implementations, the starting time domain position is a starting slot; and
the starting slot α satisfies:
   α=ƒ(the first parameter) mod N, where ƒ(the first parameter) denotes the set function, N denotes a number of slots included in a radio frame, and mod denotes a modulo operation.

In some possible implementations, the system frame number (SFN) satisfies:
SFN mod T=FLOOR(ƒ(the first parameter)/N), where T denotes a period of an SI window, ƒ(the first parameter) denotes the set function, N denotes a number of slots included in a radio frame, and FLOOR denotes a round-down operation.

In some possible implementations, the second transceiver module 1001 is further configured to receive, within the one system information time window, one DCI for scheduling the plurality of SI; and determine, according to the one DCI, a plurality of PDSCHs scheduled by the one DCI and one corresponding SI carried by each PDSCH.

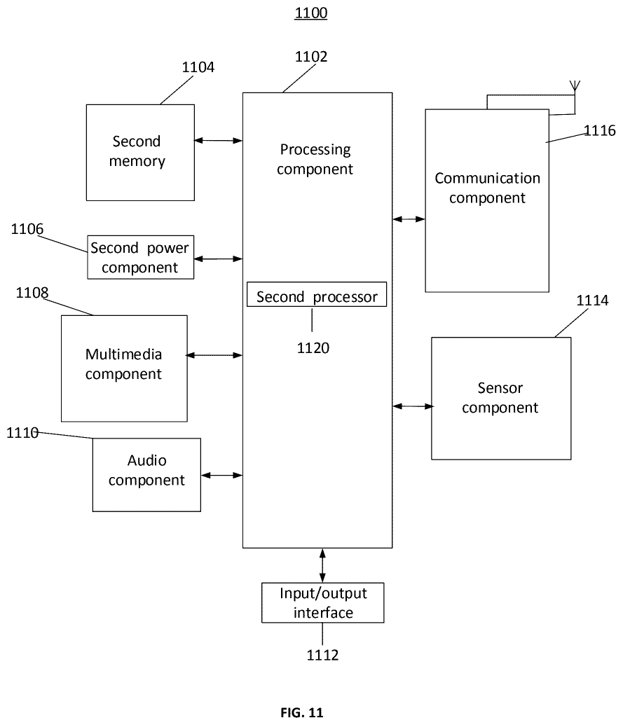

When the communication device is the user equipment 102, the structure of the communication device may also be as shown in FIG. 11. Referring to FIG. 11, a device 1100 may include one or more of the following components: a processing component 1102, a second memory 1104, a second power component 1106, a multimedia component 1108, an audio component 1110, an input/output (I/O) interface 1112, a sensor component 1114, and a communication component 1116.

The processing component 1102 typically controls the overall operation of the device 1100, such as operations associated with display, telephone call, data communication, camera operations, and recording operations. The processing component 1102 may include one or more second processors 1120 to execute instructions to complete all or part of the steps of the above methods. In addition, the processing component 1102 may include one or more modules to facilitate interactions between the processing component 1102 and other components. For example, the processing component 1102 may include a multimedia module to facilitate interactions between the multimedia component 1108 and the processing component 1102.

The second memory 1104 is configured to store various types of data to support operations at the device 1100. Examples of these data include instructions for any application or method operating on the device 1100, contact data, phonebook data, massages, pictures, videos, etc. The second memory 1104 may be implemented by any type of volatile or nonvolatile storage device or a combination of them, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or a compact disk.

The second power component 1106 provides power for various components of the device 1100. The second power component 1106 may include a power management system, one or more power sources and other components associated with generating, managing and distributing power for the device 1100.

The multimedia component 1108 includes a screen providing an output interface between the device 1100 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding and gestures on the touch panel. The touch sensor can not only sense the boundary of the touch or sliding operation, but also detect the duration and pressure related to the touch or sliding operation. In some embodiments, the multimedia component 1108 includes a front camera and/or a rear camera. When the device 1100 is in an operation mode, such as a shooting mode or a video mode, the front camera and/or the rear camera can receive external multimedia data. Each front camera and rear camera may be a fixed optical lens system or have a focal length and optical zoom capability.

The audio component 1110 is configured to output and/or input audio signals. For example, the audio component 1110 includes a microphone (MIC) configured to receive an external audio signal when the device 1000 is in an operation mode, such as a call mode, a recording mode, and a speech recognition mode. The received audio signal may be further stored in the second memory 1104 or sent via the communication component 1116. In some embodiments, the audio component 1110 also includes a speaker configured to output an audio signal.

The I/O interface 1112 provides an interface between the processing component 1102 and a peripheral interface module which may be a keyboard, a click wheel, buttons, etc. These buttons may include but are not limited to: a home button, volume buttons, a starting button and a lock button.

The sensor component 1114 includes one or more sensors configured to provide state evaluations on various aspects of the device 1100. For example, the sensor component 1114 may detect an on/off state of the device 1100 and relative positioning of the components, for example, the components are a display and a keypad of the device 1100. The sensor component 1114 may also detect a change of a position of the device 1100 or one component of the device 1100, the presence or absence of contact between the user and the device 1100, the azimuth or acceleration/deceleration of the device 1100, and a temperature change of the device 1100. The sensor component 1114 may include a proximity sensor configured to detect the presence of nearby objects without any physical contact. The sensor component 1114 may further include an optical sensor, such as a CMOS or CCD image sensor, for use in imaging applications. In some embodiments, the sensor component 1114 may further include an acceleration sensor, a gyroscope sensor, a magnetic sensor, a pressure sensor, or a temperature sensor.

The communication component 1116 is configured to facilitate wired or wireless communication between the device 1100 and other devices. The device 1100 may access a wireless network based on a communication standard, such as WiFi, 2G or 3G, or a combination of them. In an example, the communication component 1116 receives a broadcast signal or broadcast-related information from an external broadcast management system via a broadcast channel. In an example, the communication component 1116 further includes a near field communication (NFC) module to facilitate short-range communication. For example, the NFC module may be implemented based on the radio frequency identification (RFID) technology, the infrared data association (IrDA) technology, the ultra-wide band (UWB) technology, the Bluetooth (BT) technology and other technologies.

In an example, the device 1100 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the above method.

In an example, a non-transitory computer-readable storage medium including instructions, such as the second memory 1104 including instructions, is further provided. The instructions may be executed by the processor 1120 of the device 1100 to complete the above method. For example, the non-transitory computer-readable storage medium may be an ROM, a random access memory (RAM), a CD-ROM, a magnetic tape, a floppy disk, an optical data storage device, etc.

As used herein, the term processor may refer to one processor that performs the defined functions or a plurality of processors that collectively perform defined functions, such that the execution of the individual defined functions may be divided amongst such processors.

Other implementations of the embodiments of the present disclosure will be apparent to those skilled in the art from consideration of the specification and practice of the present disclosure here. The present disclosure is intended to cover any variations, uses, or adaptive changes of the embodiments of the present disclosure, these variations, uses, or adaptive changes follow the general principles of the embodiments of the present disclosure and include common general knowledge or conventional technical means, not disclosed in the present disclosure, in the technical field. The specification and embodiments are considered as examples only, and a true scope and spirit of the embodiments of the present disclosure are indicated by the following claims.

It will be appreciated that the embodiments of the present disclosure are not limited to an exact structure that has been described above and illustrated in the accompanying drawings, and various modifications and changes may be made without departing from the scope of the present disclosure. The scope of the embodiments of the present disclosure is merely limited by the appended claims.

### Industrial Applicability

In the embodiments of the present disclosure, a network device sends DCI within one system information time window to schedule a plurality of SI. In this way, the network device does not need to be in an operating state within a plurality of system information time windows, so that the time when the network device is in the operating state is shortened, and energy saving of the network device is achieved. The user equipment may monitor and receive SI within one system information time window, so that the duration for which the user equipment is in a monitoring state is shortened, and energy saving of the user equipment is achieved.

1. A method for sending system information, performed by a network device, the method comprising:
sending, within one system information time window, a downlink control information (DCI) corresponding to a plurality of system information (SI).

2. The method according to claim 1, further comprising:
determining, based on a first parameter corresponding to the plurality of SI, a time domain position of the one system information time window, wherein
the plurality of SI corresponds to the same first parameter.

3. The method according to claim 2, wherein determining, based on the first parameter corresponding to the plurality of SI, the time domain position of the one system information time window comprises:
determining, based on a set function associated with the first parameter, a starting time domain position of the one system information time window and a system frame number where the one system information time window is located.

4. The method according to claim 3, wherein the starting time domain position is a starting slot α, and
the starting slot α satisfies:
α=ƒ(the first parameter) mod N, wherein ƒ(the first parameter) denotes the set function, N denotes a number of slots comprised in a radio frame, and mod denotes a modulo operation.

5. The method according to claim 3, wherein the system frame number (SFN) satisfies:
SFN mod T=FLOOR(ƒ(the first parameter)/N), wherein T denotes a period of an SI window, ƒ(the first parameter) denotes the set function, N denotes a number of slots comprised in a radio frame, and FLOOR denotes a round-down operation.

6. The method according to claim 1, wherein sending, within the one system information time window, the downlink control information (DCI) corresponding to the plurality of system information (SI) comprises:
sending, within the one system information time window, one DCI for scheduling the plurality of SI, wherein the one DCI is configured to schedule a plurality of physical downlink shared channels (PDSCHs), and each PDSCH carries one corresponding SI among the plurality of SI.

7. The method according to claim 6, wherein SI corresponding by default to the one system information time window is carried on a first PDSCH among the plurality of PDSCHs scheduled by the one DCI.

8. The method according to claim 6, further comprising at least one of the following:
sending a first signaling, wherein the first signaling is configured to indicate that the plurality of PDSCHs are allowed to be scheduled via the one DCI for transmission of the plurality of SI; or
sending a second signaling, wherein the second signaling is configured to indicate a number of the PDSCHs scheduled via the one DCI.

9. (canceled)

10. The method according to claim 6, wherein
a set information field of the one DCI is configured to indicate a number of the PDSCHs scheduled by the one DCI, wherein the set information field is configured in a reserved bit of the one DCI.

11-12. (canceled)

13. A method for receiving system information, performed by a user equipment, the method comprising:
receiving, within one system information time window, a downlink control information (DCI) corresponding to a plurality of system information (SI).

14. The method according to claim 13, further comprising:
determining, based on a first parameter corresponding to the plurality of SI, a time domain position of the one system information time window, wherein
the plurality of SI corresponds to the same first parameter.

15. The method according to claim 14, further comprising:
receiving information sent by a network device for configuring the first parameter.

16. The method according to claim 14, wherein determining, based on the first parameter corresponding to the plurality of SI, the time domain position of the one system information time window comprises:
determining, based on a set function associated with the first parameter, a starting time domain position of the one system information time window and a system frame number where the one system information time window is located.

17. The method according to claim 16, wherein the starting time domain position is a starting slot α, and
the starting slot α satisfies:
α=ƒ(the first parameter) mod N, wherein ƒ(the first parameter) denotes the set function, N denotes a number of slots comprised in a radio frame, and mod denotes a modulo operation.

18. The method according to claim 16, wherein the system frame number (SFN) satisfies:
SFN mod T=FLOOR(ƒ(the first parameter)/N), wherein T denotes a period of an SI window, ƒ(the first parameter) denotes the set function, N denotes a number of slots comprised in a radio frame, and FLOOR denotes a round-down operation.

19. The method according to claim 13, wherein receiving, within one system information time window, the DCI corresponding to the plurality of SI comprises:
receiving, within the one system information time window, one DCI for scheduling the plurality of SI; and
determining, according to the one DCI, a plurality of PDSCHs scheduled by the one DCI and one corresponding SI carried by each PDSCH.

20-21. (canceled)

22. A communication device comprising one or more processors and a memory, wherein
the memory is configured to store a computer program; and
the one or more processors are collectively configured to execute the computer program to:
send, within one system information time window, a downlink control information (DCI) corresponding to a plurality of system information (SI).

23. A communication device comprising one or more processors and a memory, wherein
the memory is configured to store a computer program; and
the one or more processors are collectively configured to execute the computer program to implement the method according to claim 13.

24. A non-transitory computer-readable storage medium storing instructions, wherein the instructions, when executed on a computer, cause the computer to perform the method according to claim 1.

25. A non-transitory computer-readable storage medium storing instructions, wherein the instructions, when executed on a computer, cause the computer to perform the method according to claim 13.
